(19) United States
(12) Patent Application Publication
(10) Pub. No.: US 2012/0247999 A1
(43) Pub. Date: Oct. 4, 2012

(54) CRYOPRESERVATION DEVICE

(75) Inventors: Sayaka Nishio, Tokyo (JP); Hidetoshi Oota, Tokyo (JP); Mamoru Fujita, Tokyo (JP)

(73) Assignee: TAIYO NIPPON SANSO CORPORATION, Tokyo (JP)

(21) Appl. No.: 13/434,025

(22) Filed: Mar. 29, 2012

(30) Foreign Application Priority Data
Mar. 31, 2011 (JP) 2011-79110

(51) Int. Cl. F17C 1/00; B65D 85/00

(52) U.S. Cl. 206/459.5; 220/560.09

(57) ABSTRACT

Provided is a cryopreservation device which is small-sized and light-weight and has a low price, and also which is easy to get a cryocane in and out of.

The cryopreservation device is configured to include first rotation lid 13 rotatably mounted on upper opening of container body 11, second rotation lid 14 rotatably provided on circular opening provided on the first rotation lid, through-hole for getting a cryocane in and out of provided on the second rotation lid, tubular body 15 provided in a protruding manner upward from the second rotation lid, lifting device 16 arranged inside the tubular body, cane gripper 17 provided on the lifting device, and door 18 provided on the tubular body, wherein any of cryocanes held at a center portion to the periphery of the container body on the cryocane holder can be gripped by rotating the first rotation lid with respect to the upper opening and by rotating the second rotation lid with respect to the first rotation lid to adjust the position of the through-hole.

### TECHNICAL FIELD

The present invention relates to a cryopreservation device, and particularly to a cryopreservation device provided with means for getting a cryocane holding a plurality of cryovials or ampules enclosing a cryopreservation sample in and out of a cryopreservation container storing a cryogenic liquefied gas.

### BACKGROUND ART

As a means for getting a sample preserved in a cryopreservation container from the container, a cryopreservation device such that a handling robot is arranged at an upper part of the cryopreservation container, and that the handling robot takes out automatically an objective cryocane in the cryopreservation container based on the information input from an input device and on the information which is attached to a cryocane (ampule casing member) preserved cryopreservation container is known (see, for example, Patent Literature 1).

### CITATION LIST

### Patent Literature

[Patent Literature 1] JP 2010-94359 A

### SUMMARY OF THE INVENTION

### Problems to be Solved by the Invention

However, a cryopreservation device described in Patent Literature 1 is not suitable for a relatively small-sized laboratory or the like although the device is suitable for applications for getting many samples in and out of, since the size and the mass of the device are large, and the device is expensive because the cryopreservation device has a complex structure and requires an expensive handling robot or control device.

Accordingly, an object of the present invention is to provide a cryopreservation device which is small-sized and light-weight and has a low price, and also which is easy to get a cryocane in and out of.

### Means for Solving the Problems

In order to attain the above object, the present invention provides, in the first constitution, a cryopreservation device comprising a cylindrical container body storing cryogenic liquefied gas and a cryocane holder which is provided in the container body and which has a plurality of cane casing portions holding a cryocane to be inserted from an upper opening of the container body, the cryopreservation device comprising:

a first rotation lid which is rotatably mounted on the upper opening of the container body and which covers whole of the upper opening;

a second rotation lid which is rotatably mounted on a circular opening provided on a part of the first rotation lid and which covers whole of the circular opening;

a through-hole for getting a cryocane in and out of which is provided on a part of the second rotation lid;

a tubular body which is provided in a protruding manner upward from the periphery of the second rotation lid;

a lifting device which is arranged inside the tubular body;

a cane gripper which is provided on the lifting device and which can grip the top end of the cryocane; and

a door which is provided on a lower part of the surrounding wall of the tubular body, wherein

the center of the upper opening and the rotation center of the first rotation lid are in the same vertical line;

the circular opening has a diameter smaller than the diameter of the first rotation lid and larger than the radius of the first rotation lid;

the center of the circular opening is provided at a position deviated from the rotation center of the first rotation lid;

the center of the circular opening and the rotation center of the second rotation lid are in the same vertical line; and

the center of the through-hole is provided at a position deviated from the rotation center of the second rotation lid, and wherein

the device is configured such that any of cryocanes held at a center portion of the container body on the cryocane holder and cryocanes held on the periphery of the container body on the cryocane holder can be gripped by the cane gripper through the through-hole by rotating the first rotation lid with respect to the upper opening and by rotating the second rotation lid with respect to the first rotation lid to adjust the position of the through-hole.

The present invention provides, in the second constitution, a cryopreservation device comprising a cylindrical container body storing cryogenic liquefied gas and a cryocane holder which is provided in the container body and which has a plurality of cane casing portions holding a cryocane to be inserted from an upper opening of the container body, the cryopreservation device comprising:

a first rotation lid which is rotatably mounted on the upper opening of the container body and which covers whole of the upper opening;

a second rotation lid which is rotatably mounted on a circular opening provided on a part of the first rotation lid and which covers whole of the circular opening;

a through-hole for getting a cryocane in and out of which is provided on a part of the second rotation lid;

a tubular body which is provided rotatably in a protruding manner upward from the periphery of the through hole;

a lifting device which is provided in a protruding manner upward from the top surface of the second rotation lid;

a cane gripper which is provided on the lifting device, which is liftable inside the tubular body and which can grip the top end of the cryocane; and

a door which is provided on a lower part of the surrounding wall of the tubular body, wherein

the center of the upper opening and the rotation center of the first rotation lid are in the same vertical line;

the circular opening has a diameter smaller than the diameter of the first rotation lid and larger than the radius of the first rotation lid;

the center of the circular opening is provided at a position deviated from the rotation center of the first rotation lid;

the center of the circular opening and the rotation center of the second rotation lid are in the same vertical line; and

the center of the through-hole is provided at a position deviated from the rotation center of the second rotation lid, and wherein

the device is configured such that any of the cryocane held at a center portion of the container body on the cryocane holder and a cryocane held on the periphery of the container body on the cryocane holder can be gripped by the cane gripper through the through-hole by rotating the first rotation lid with respect to the upper opening and by rotating the second rotation lid with respect to the first rotation lid to adjust the position of the through-hole.

The present invention provides, in the third constitution, a cryopreservation device comprising a cylindrical container body storing cryogenic liquefied gas and a cryocane holder which is provided in the container body and which has a plurality of cane casing portions holding a cryocane to be inserted from an upper opening of the container body, the cryopreservation device comprising:

a disc-shaped lid which covers the upper opening of the container body;

a slit for getting a cryocane in and out of which is configured in a rectangular shape stretching in the radius direction of the lid;

a tubular body which is provided in a protruding manner upward from the periphery of the lid;

a lifting device which is arranged inside the tubular body;

a cane gripper which is provided on the lifting device, which is configured to be movable and liftable along the longitudinal direction of the slit and which can grip the top end of the cryocane; and

a door which is provided on a lower part of the surrounding wall of the tubular body corresponding to the outer end of the slit, wherein

the slit is positioned such that the inner end of the slit is at the center of the lid and the outer end of the slit is positioned at the periphery of the lid and the slid has a length smaller than the diameter of the lid and larger than the radius of the lid;

the cryocane holder is configured to be rotatable around the center of the cryocane holder as an axis in the container body; and wherein

the device is configured such that any of the cryocane held at a center portion of the container body on the cryocane holder and a cryocane held on the periphery of the container body on the cryocane holder can be gripped by the cane gripper through the slit by rotating the cryocane holder and by adjusting the position of the cane gripper in the longitudinal direction of the slit.

Further, in the present invention, the cryopreservation device in the first constitution or the second constitution is characterized in that, in place of rotatably mounting the first rotation lid on the upper opening of the container body, the first rotation lid is supported above the upper opening of the container body by a lid supporting means; the container body is supported by a rotatable rotating table; and the center of the first body and the rotation center of the container body are arranged in the same vertical line. The cryopreservation device in each of the above constitutions is characterized in that the head portion of a cryocane is provided with an identifier for identifying each cryocane and characterized in that the cane gripper is provided with an identifier reading means for reading the identifier.

### Effect of the Invention

By the cryopreservation device of the present invention, a cryocane can be taken out from a container body by using a lifting device having a simple constitution, and the whole device can be small-sized and light-weight and the device can have a low cost.

### BRIEF DESCRIPTION OF DRAWINGS

FIG. 1 is a perspective view of a first embodiment of a cryopreservation device of the present invention.

FIG. 2 is a plain sectional view of the first embodiment of a cryopreservation device of the present invention.

FIG. 3 is a front sectional view of the first embodiment of a cryopreservation device of the present invention.

FIG. 4 is a front sectional view of a main part of the first embodiment of a cryopreservation device of the present invention.

FIG. 5 is a perspective view of a second embodiment of a cryopreservation device of the present invention.

FIG. 6 is a plain sectional view of the second embodiment of a cryopreservation device of the present invention.

FIG. 7 is a front sectional view of the second embodiment of a cryopreservation device of the present invention.

FIG. 8 is a front sectional view of a main part of the second embodiment of a cryopreservation device of the present invention.

FIG. 9 is a perspective view of a third embodiment of a cryopreservation device of the present invention.

FIG. 10 is a plain sectional view of the third embodiment of a cryopreservation device of the present invention.

FIG. 11 is a front sectional view of the third embodiment of a cryopreservation device of the present invention.

FIG. 12 is a front sectional view of a main part of the third embodiment of a cryopreservation device of the present invention.

FIG. 13 is a perspective view of a fourth embodiment of a cryopreservation device of the present invention.

FIG. 14 is a front sectional view of a fifth embodiment of a cryopreservation device of the present invention.

### MODES FOR CARRYING OUT THE INVENTION

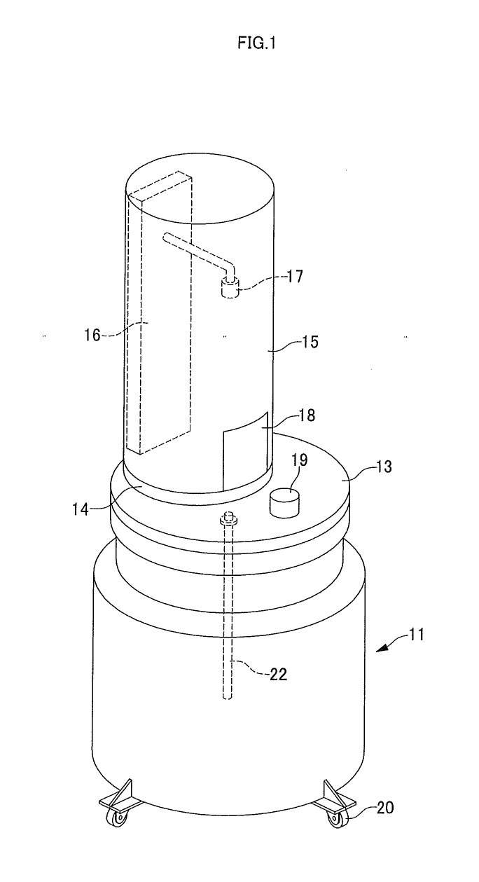

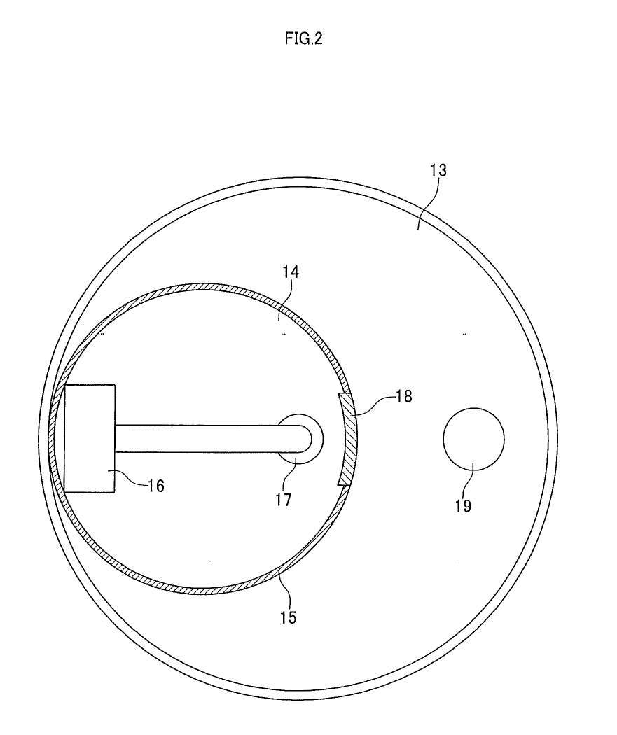

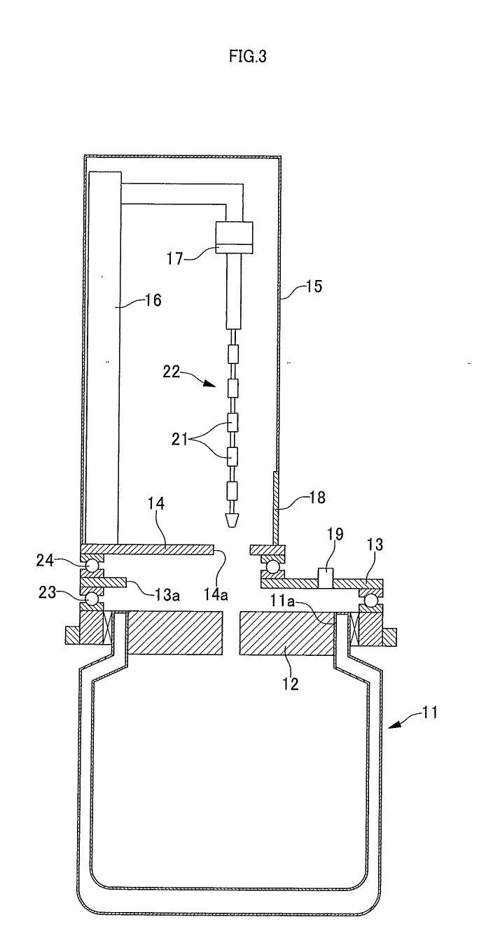

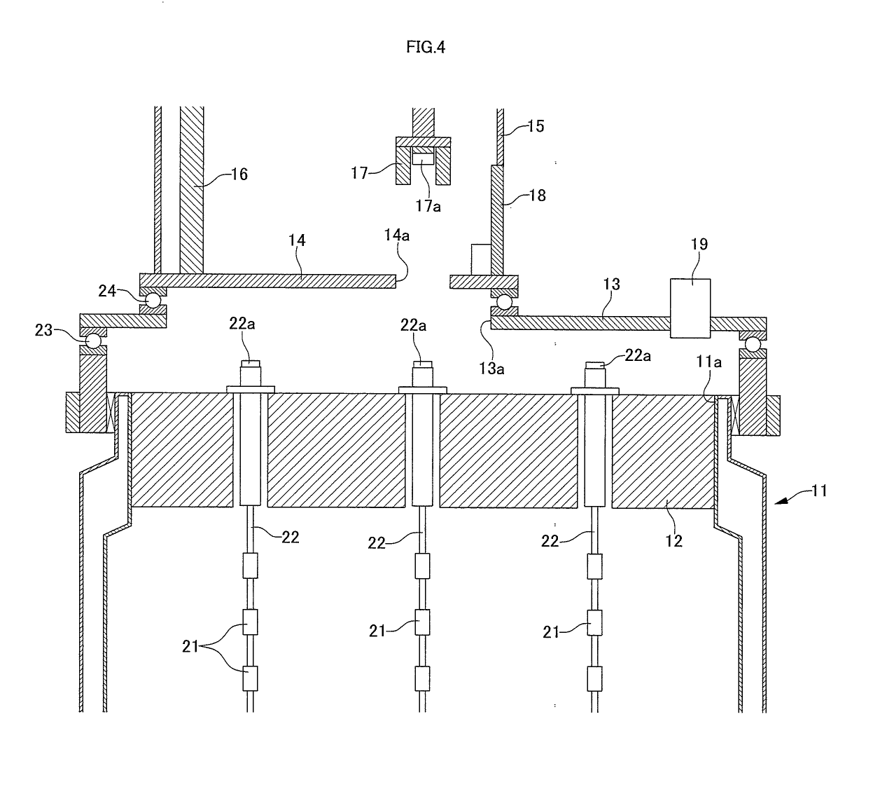

First, a cryopreservation device represented by the first embodiment in FIGS. 1 to 4 comprises cylindrical container body 11 storing cryogenic liquefied gas, cryocane holder 12 provided in the container body 11, first rotation lid 13 rotatably mounted on upper opening 11a of container body 11, second rotation lid 14 rotatably provided on circular opening 13a provided on a part of first rotation lid 13, tubular body 15 provided in a protruding manner upward from the periphery of second rotation lid 14, lifting device 16 arranged inside tubular body 15, cane gripper 17 provided on lifting device 16, through-hole 14a for getting a cryocane in and out of provided on second rotation lid 14 and door 18 provided on a lower part of the surrounding wall of tubular body 15.

First rotation lid 13 is provided with exhaust tube 19 and the bottom of container body 11 is provided with caster 20. Herein, a detailed illustration and explanation of container body 11 and cryocane holder 12 are omitted since the same illustration and explanation as in the cryopreservation container described in Patent Literature 1 can be used.

cryocane holder 12 holds cryocane 22 in a vertical direction by supporting an upper part of a number of cryocane 22 holding a plurality of cryovial 21 and ampules. Each cryocane 22 is provided vertically with a multiple holding portions holding a plurality of cryovial 21 enclosing a cryopreservation sample. Head portion of cryocane 22 is provided with an identifier 22a for identifying cryocane 22. Such identifier 22a is configured to be readable from upward. As the identifier, visible numerals or characters, or a variety of barcodes which are readable by a reader for the barcodes can be employed.

First rotation lid 13 covering whole of upper opening 11a is composed of a disc-shaped member having a diameter larger than the diameter of upper opening 11a of container body 11, and is mounted on container body 11 via a first rotation supporting member (bearing) 23 provided between the periphery of upper opening 11a and the periphery of first rotation lid 13 such that the rotation center of first rotation lid 13 and the center of upper opening 11a are positioned in the same vertical line. Circular opening 13a provided on first rotation lid 13 is an opening whose planar view is circle having a diameter smaller than the diameter of first rotation lid 13 and larger than the radius of first rotation lid 13, and is arranged such that the center of circular opening 13a is at a position deviated from the rotation center of first rotation lid 13, and that the periphery of first rotation lid 13 is close to circular opening 13a.

Second rotation lid 14 covering circular opening 13a is composed of a disc-shaped member having a diameter larger than the diameter of circular opening 13a, and is provided via a second rotation supporting member (bearing) 24 provided between the top surface of the periphery of circular opening 13a and the bottom surface of the periphery of second rotation lid 14 such that the center of circular opening 13a and the rotation center of second rotation lid 14 are positioned in the same vertical line. Through-hole 14a for getting a cryocane in and out of provided on second rotation lid 14 has such a size that cane gripper 17 or cryocane 22 of lifting device 16 can pass through, and is arranged such that the center of through-hole 14a is at a position deviated from the rotation center of second rotation lid 14 and that through-hole 14a is closed to the periphery of second rotation lid 14.

Tubular body 15 is composed of a cylindrical member having a lid, the member being vertically provided from the periphery of second rotation lid 14. The diameter of tubular body 15 and the diameter of second rotation lid 14 are nearly the same and the center axis of tubular body 15 and the rotation center of second rotation lid 14 are positioned in the same vertical line. The height of tubular body 15 is set to a height by which tubular body 15 can receive lifting device 16.

In lifting device 16 provided in tubular body 15, cane gripper 17 is liftable in vertical direction between a lowered position in which the head portion of cryocane 22 held by cryocane holder 12 can be gripped by cane gripper 17 and an elevated position in which whole of cryocane 22 gripped by cane gripper 17 is pulled upward above second rotation lid 14. On the tip of cane gripper 17, reader (reading means) 17a is provided for reading identifier 22a provided on the head portion of cryocane 22, and a gripping mechanism for gripping detachably the head portion of cryocane 22 is provided.

Door 18 is opened when cryovial 21 is detached to a prescribed position of cryocane 22, and is configured to have a size by which the operation of taking cryovial 21 held at a prescribed position of cryocane 22 which is elevated at a prescribed height by cane gripper 17 out can be performed.

In a cryopreservation device configured in such a manner, when cryovial 21 enclosing a desired sample preserved in container body 11 is taken out, through-hole 14a for getting a cryocane in and out of is moved above cryocane 22 holding objective cryovial 21 by rotating first rotation lid 13 with respect to upper opening 11a of container body 11 and by rotating second rotation lid 14 with respect to first rotation lid 13. The positioning of through-hole 14a can also be performed manually by visual inspection of identifier 22a provided on the head portion of cryocane 22, and can also be performed automatically based on the positional information stored in advance in a memorizing means.

In this case, by setting the size or the position of second rotation lid 14 with respect to first rotation lid 13 in the above-mentioned manner, cryocane 22 held at a center portion of container body 11 can be taken out by positioning through-hole 14a of second rotation lid 14 inside the internal circumference of first rotation lid 13, and cryocane 22 held at the periphery of container body 11 can be taken out by positioning through-hole 14a of second rotation lid 14 outside the outer circumference of first rotation lid 13. That is, by adjusting the rotation position of first rotation lid 13 with respect to upper opening 11a and by adjusting the rotation position of second rotation lid 14 with respect to first rotation lid 13, cryocane 22 held anywhere on cryocane holder 12 in container body 11 can be taken out.

After positioning through-hole 14a above objective cryocane 22, cane gripper 17 is lowered by lifting device 16 through through-hole 14a, and the head portion of objective cryocane 22 is gripped by cane gripper 17. In this case, by using reader 17a provided on cane gripper 17, and by reading identifier 22a of cryocane 22 to be verified, objective cryocane 22 can be surely gripped without fail.

By operating lifting device 16 in a state that objective cryocane 22 is gripped by cane gripper 17, cane gripper 17 is elevated to a position where desired cryovial 21 held by cryocane 22 can be taken out from door 18, door 18 is opened and desired cryovial 21 is detached from cryocane 22. The elevated position of cryocane 22 can also be confirmed by visual inspection, and the positioning thereof can be performed by attaching identifier for cryovials on cryovial 21, by providing the vicinity of door 18 with a reader, and by reading the identifier for cryovials to be verified. As mentioned above, the position can be controlled automatically based on the positional information stored in advance in a memorizing means.

As mentioned above, only by rotating first rotation lid 13 and second rotation lid 14, and by operating lifting device 16, cryovial 21 enclosing a desired sample can easily be taken out. By configuring all of the rotating operation of each of lid 13 and 14, the lifting operation of lifting device 16 and the gripping operation of cane gripper 17 to be manually operated, a complex mechanism can become unnecessary, whereby the whole cryopreservation device comprising a cryocane taking out device can be made small-sized and light-weight and have a low price. Also in the case of automating the lifting operations of lifting device 16 including the gripping operation of cane gripper 17, the automation can be easily attained by small addition since the movement required for lifting device 16 is only in a vertical direction.

Further, an appropriate management thereof can be performed by combining a simple identifier and a reader, and survey camera and monitor display can be appropriately used. Further, by providing container body 11 with caster 20, the movement of the cryopreservation device can also be easily performed. Further, by forming first rotation lid 13, second rotation lid 14, tubular body 15 and door 18 of a transparent material, the position of cryocane 22 can be visually confirmed from outside during the operation, whereby the operability can be considerably improved.

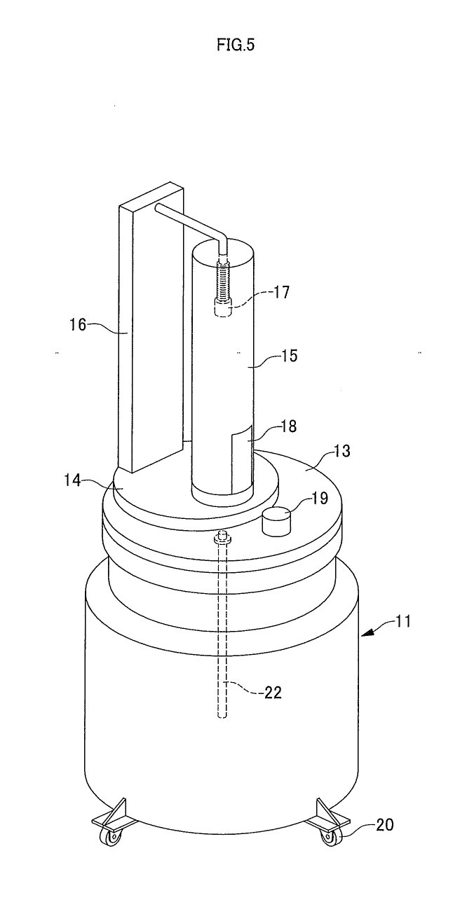

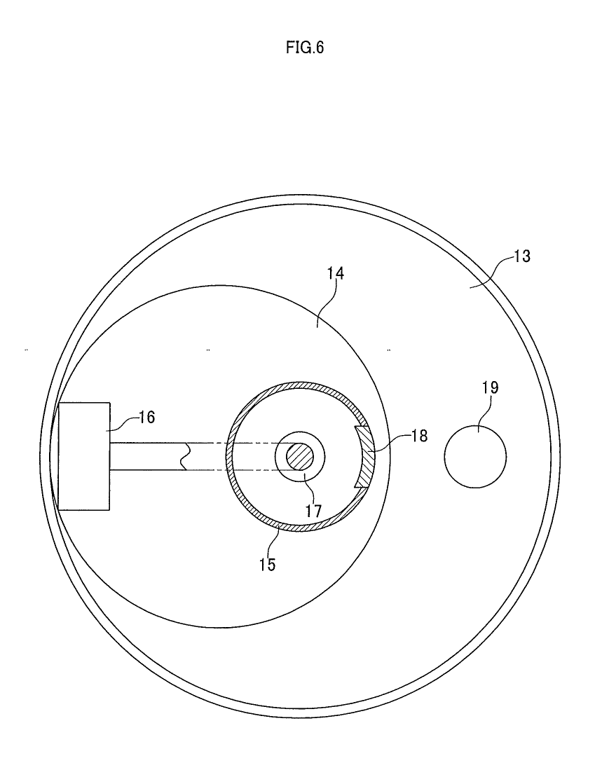

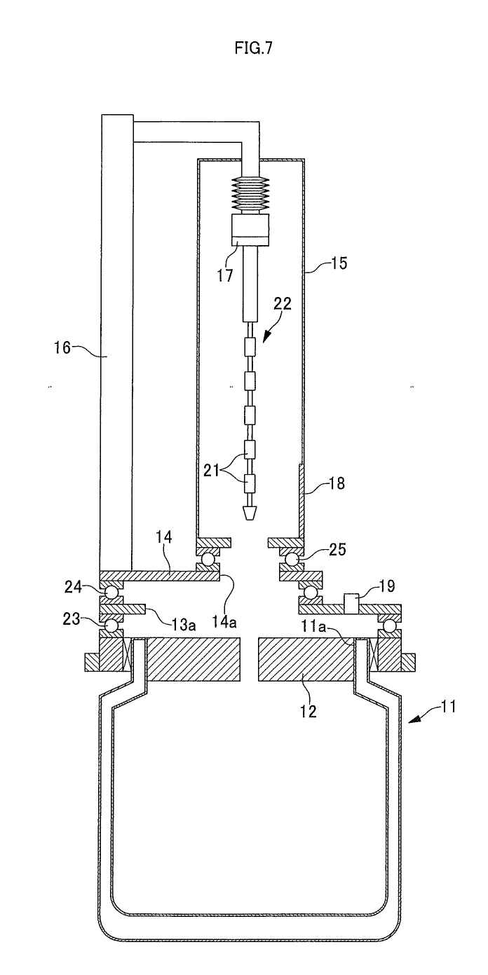

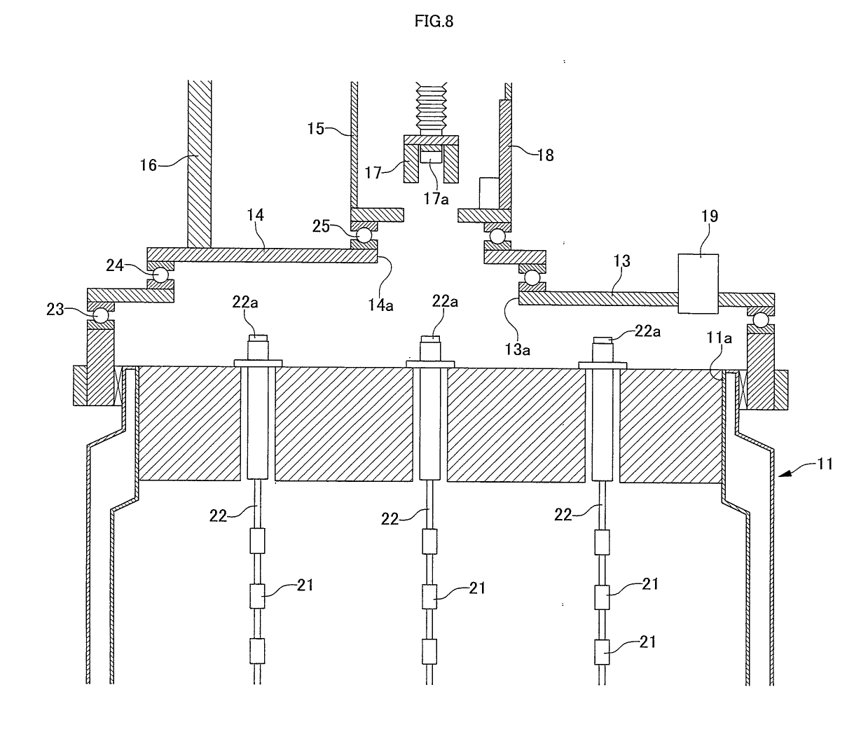

FIGS. 5 to 8 represent the second embodiment of a cryopreservation device of the present invention. In the following description, the same sign is assigned to the same component in each cryopreservation device and the description thereof in detail is omitted.

In this embodiment, tubular body 15 is vertically rotatably provided via a third rotation supporting member 25 provided on the periphery of through-hole 14a by making the diameter of tubular body 15 provided on second rotation lid 14 smaller than the diameter of second rotation lid 14; and lifting device 16 is vertically provided on second rotation lid 14 outside tubular body 15, and is configured to lift cane gripper 17 inside tubular body 15 in a state that the top of tubular body 15 is airtightly penetrated.

By rotatably configuring tubular body 15 in such a way, the operation of taking cryovial 21 out can be effectively performed since the direction of door 18 can be adjusted to the direction in which the operation of taking cryovial 21 out is performed by rotating tubular body 15 when cryovial 21 is taken out from cryocane 22 pulled upward by cane gripper 17.

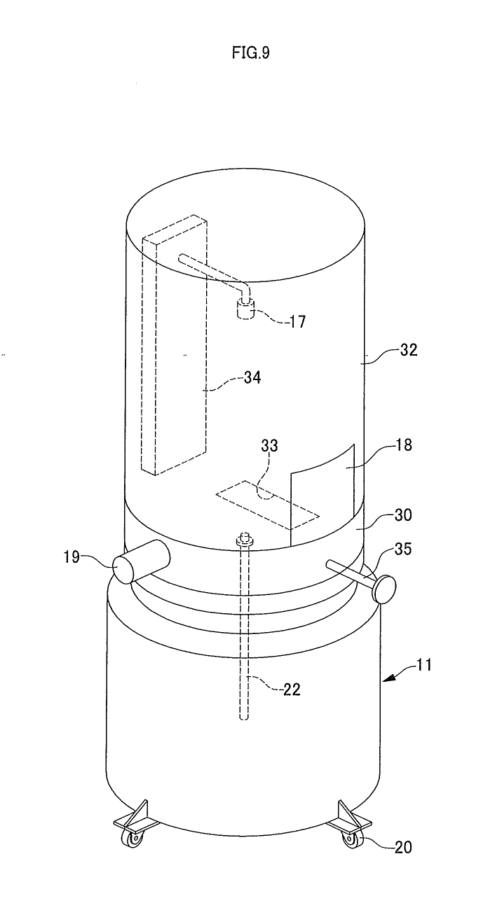

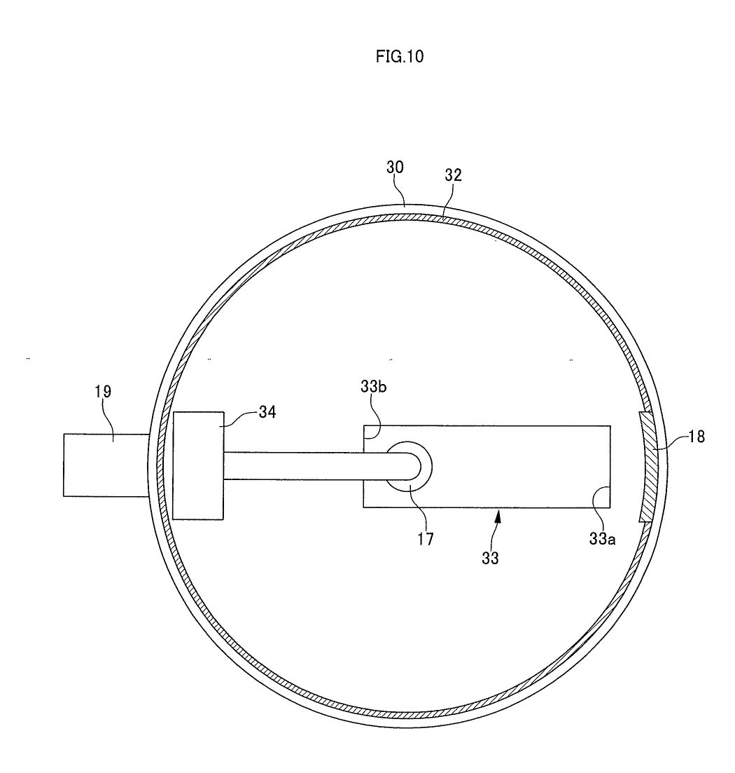

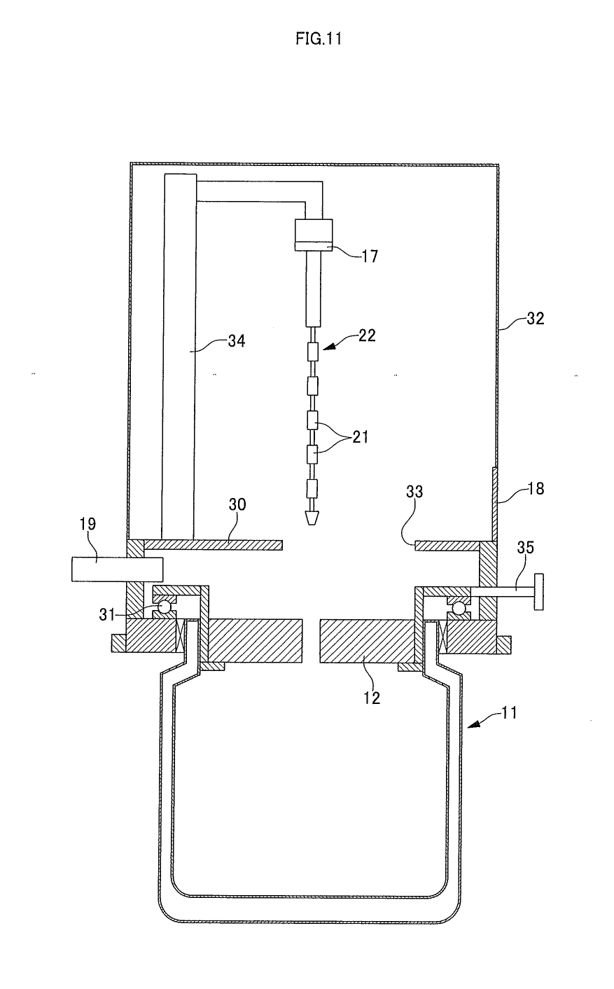

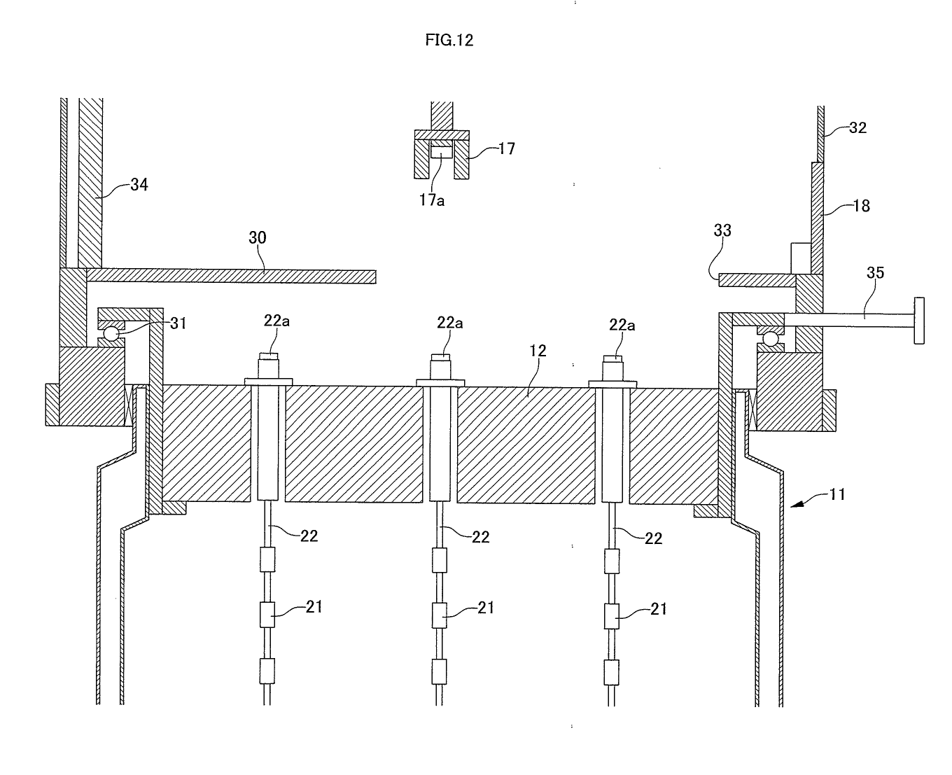

FIGS. 9 to 12 represent the third embodiment of a cryopreservation device of the present invention. In this embodiment, disc-shaped lid 30 is fixed to upper opening 11a, cryocane holder 12 is supported by rotation supporting member 31, and the lid is configured to be rotatable around a vertical line passing the center of cryocane holder 12 as a rotation axis inside container body 11. On lid 30, tubular body 32 having a diameter nearly equal to the diameter of lid 30 is vertically provided, slit 33 for getting a cryocane in and out of which is configured in a rectangular shape stretching in the radius direction of lid 30 is provided, lifting device 34 having cane gripper 17 configured to be movable and liftable along the longitudinal direction of slit 33 inside tubular body 32 on lid 30 is provided, and further, door 18 is provided on a lower part of surrounding wall of tubular body 32 corresponding to outer end 33a of slit 33. Slit 33 has a length smaller than the diameter of lid 30 and larger than the radius of lid 30, and is arranged such that inner end 33b is positioned at the center of lid 30, and outer end 33a is positioned at the periphery of lid 30.

In the cryopreservation device represented by this embodiment, the device is configured such that any of cryocane 22 held at a center portion of container body 11 on cryocane holder 12 and cryocane 22 held on the periphery of container body 11 on cryocane holder 12 can be gripped by cane gripper 17 through slit 33 by rotating cryocane holder 12 inside container body 11 and by adjusting the position of cane gripper 17 in the longitudinal direction of slit 33. The rotation of cryocane holder 12 can be performed by rotation handle 35 provided at an appropriate position. In place of slit 33, the circular opening represented by each of the above embodiments can be employed.

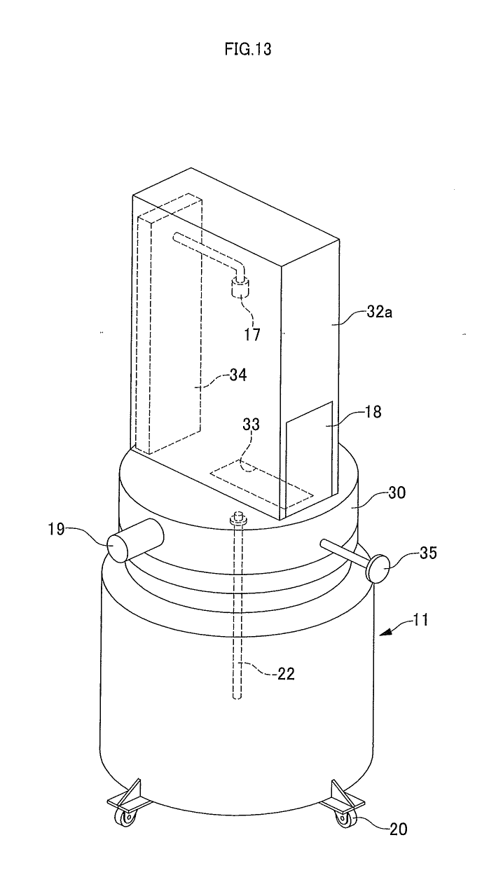

FIG. 13 represents the forth embodiment of a cryopreservation device of the present invention. In this embodiment, cylindrical tubular body 32 in the third embodiment is replaced with square tubular body 32a in which the range of adjusting position of slit 33 and cane gripper 17, and a cryopreservation device is configured in the same manner as in the cryopreservation device represented in the third embodiment except for the shapes of the tubular bodies.

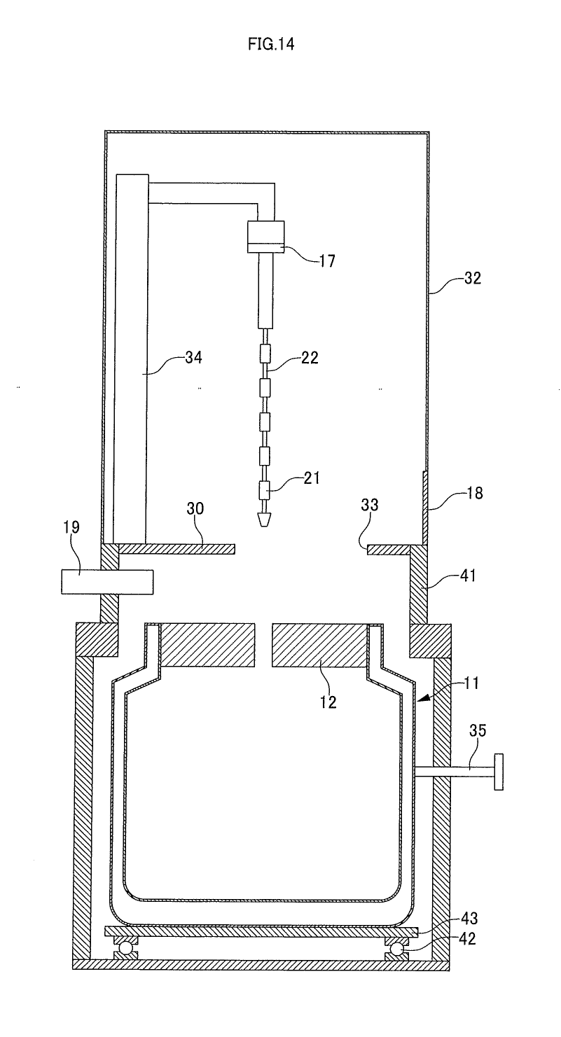

FIG. 14 represents the fifth embodiment of a cryopreservation device of the present invention. In this embodiment, there is illustrated an example of cryopreservation device in which lid 30 is unrotatably supported by lid supporting means 41 above the upper opening 11a of container body 11, container body 11 is rotatably supported by rotating table 43 comprising rotation supporting member 42, and the center of lid 30 and the rotation center of container body 11 are arranged in the same vertical line. In this embodiment, without rotating lid 30 and by rotating container body 11 via rotating table 43, cryocane 22 can be taken out from any positions in container body 11 in the same manner as in each of the above embodiments.

### Description of Symbols

11 . . . container body, 11a . . . upper opening, 12 . . . cryocane holder, 13 . . . first rotation lid, 13a . . . circular opening, 14 . . . second rotation lid, 14a . . . through-hole, 15 . . . tubular body, 16 . . . lifting device, 17 . . . cane gripper, 17a . . . reader, 18 . . . door, 19 . . . exhaust tube, 20 . . . caster, 21 . . . cryovial, 22 . . . cryocane, 22a . . . identifier, 23 . . . first rotation supporting member, 24 . . . second rotation supporting member, 25 . . . third rotation supporting member, 30 . . . lid, 31 . . . rotation supporting member, 32 . . . tubular body, 33 . . . slit, 33a . . . outer end, 33b . . . inner end, 34 . . . lifting device, 35 . . . rotation handle, 41 . . . lid supporting means, 42 . . . rotation supporting member, 43 . . . rotating table

1. A cryopreservation device comprising a cylindrical container body storing cryogenic liquefied gas and a cryocane holder which is provided in the container body and which has a plurality of cane casing portions holding a cryocane to be inserted from an upper opening of the container body, the cryopreservation device comprising:
a first rotation lid which is rotatably mounted on the upper opening of the container body and which covers whole of the upper opening;
a second rotation lid which is rotatably mounted on a circular opening provided on a part of the first rotation lid and which covers whole of the circular opening;
a through-hole for getting a cryocane in and out of which is provided on a part of the second rotation lid;
a tubular body which is provided in a protruding manner upward from the periphery of the second rotation lid;
a lifting device which is arranged inside the tubular body;
a cane gripper which is provided on the lifting device and which can grip the top end of the cryocane; and
a door which is provided on a lower part of the surrounding wall of the tubular body, wherein
the center of the upper opening and the rotation center of the first rotation lid are in the same vertical line;
the circular opening has a diameter smaller than the diameter of the first rotation lid and larger than the radius of the first rotation lid;
the center of the circular opening is provided at a position deviated from the rotation center of the first rotation lid;
the center of the circular opening and the rotation center of the second rotation lid are in the same vertical line; and
the center of the through-hole is provided at a position deviated from the rotation center of the second rotation lid, and wherein
the device is configured such that any of the cryocane held at a center portion of the container body on the cryocane holder and a cryocane held on the periphery of the container body on the cryocane holder can be gripped by the cane gripper through the through-hole by rotating the first rotation lid with respect to the upper opening and by rotating the second rotation lid with respect to the first rotation lid to adjusting the position of the through-hole.

2. A cryopreservation device comprising a cylindrical container body storing cryogenic liquefied gas and a cryocane holder which is provided in the container body and which has a plurality of cane casing portions holding a cryocane to be inserted from an upper opening of the container body, the cryopreservation device comprising:
a first rotation lid which is rotatably mounted on the upper opening of the container body and which covers whole of the upper opening;
a second rotation lid which is rotatably mounted on a circular opening provided on a part of the first rotation lid and which covers whole of the circular opening;
a through-hole for getting a cryocane in and out of which is provided on a part of the second rotation lid;
a tubular body which is provided rotatably in a protruding manner upward from the periphery of the through hole;
a lifting device which is provided in a protruding manner upward from the top surface of the second rotation lid;
a cane gripper which is provided on the lifting device, which is liftable inside the tubular body and which can grip the top end of the cryocane; and
a door which is provided on a lower part of the surrounding wall of the tubular body, wherein
the center of the upper opening and the rotation center of the first rotation lid are in the same vertical line;
the circular opening has a diameter smaller than the diameter of the first rotation lid and larger than the radius of the first rotation lid;
the center of the circular opening is provided at a position deviated from the rotation center of the first rotation lid;
the center of the circular opening and the rotation center of the second rotation lid are in the same vertical line; and
the center of the through-hole is provided at a position deviated from the rotation center of the second rotation lid, and wherein
the device is configured such that any of the cryocane held at a center portion of the container body on the cryocane holder and a cryocane held on the periphery of the container body on the cryocane holder can be gripped by the cane gripper through the through-hole by rotating the first rotation lid with respect to the upper opening and by rotating the second rotation lid with respect to the first rotation lid to adjust the position of the through-hole.

3. The cryopreservation device according to claim 1, wherein, in place of rotatably mounting the first rotation lid on the upper opening of the container body, the first rotation lid is supported above the upper opening of the container body by a lid supporting means; the container body is supported by a rotatable rotating table; and the center of the first body and the rotation center of the container body are arranged in the same vertical line.

4. The cryopreservation device according to claim 2, wherein, in place of rotatably mounting the first rotation lid on the upper opening of the container body, the first rotation lid is supported above the upper opening of the container body by a lid supporting means; the container body is supported by a rotatable rotating table; and the center of the first body and the rotation center of the container body are arranged in the same vertical line.

5. A cryopreservation device comprising a cylindrical container body storing cryogenic liquefied gas and a cryocane holder which is provided in the container body and which has a plurality of cane casing portions holding a cryocane to be inserted from an upper opening of the container body, the cryopreservation device comprising:
a disc-shaped lid which covers the upper opening of the container body;
a slit for getting a cryocane in and out of which is configured in a rectangular shape stretching in the radius direction of the lid;
a tubular body which is provided in a protruding manner upward from the periphery of the lid;
a lifting device which is arranged inside the tubular body;
a cane gripper which is provided on the lifting device, which is configured to be movable and liftable along the longitudinal direction of the slit and which can grip the top end of the cryocane; and
a door which is provided on a lower part of the surrounding wall of the tubular body corresponding to the outer end of the slit, wherein
the slit is positioned such that the inner end of the slit is at the center of the lid and the outer end of the slit is positioned at the periphery of the lid and the slid has a length smaller than the diameter of the lid and larger than the radius of the lid;
the cryocane holder is configured to be rotatable around the center of the cryocane holder as an axis in the container body; and wherein
the device is configured such that any of the cryocane held at a center portion of the container body on the cryocane holder and a cryocane held on the periphery of the container body on the cryocane holder can be gripped by the cane gripper through the slit by rotating the cryocane holder and by adjusting the position of the cane gripper in the longitudinal direction of the slit.

6. The cryopreservation device according to claim 1, wherein the head portion of the cryocane is provided with an identifier for identifying each cryocane.

7. The cryopreservation device according to claim 2, wherein the head portion of the cryocane is provided with an identifier for identifying each cryocane.

8. The cryopreservation device according to claim 3, wherein the head portion of the cryocane is provided with an identifier for identifying each cryocane.

9. The cryopreservation device according to claim 4, wherein the head portion of the cryocane is provided with an identifier for identifying each cryocane.

10. The cryopreservation device according to claim 5, wherein the head portion of the cryocane is provided with an identifier for identifying each cryocane.

11. The cryopreservation device according to claim 6, wherein the cane gripper is provided with an identifier reading means for reading the identifier.

12. The cryopreservation device according to claim 7, wherein the cane gripper is provided with an identifier reading means for reading the identifier.

13. The cryopreservation device according to claim 8, wherein the cane gripper is provided with an identifier reading means for reading the identifier.

14. The cryopreservation device according to claim 9, wherein the cane gripper is provided with an identifier reading means for reading the identifier.

15. The cryopreservation device according to claim 10, wherein the cane gripper is provided with an identifier reading means for reading the identifier.
